(19) United States
(12) Patent Application Publication
(10) Pub. No.: US 2026/0149647 A1
(43) Pub. Date: May 28, 2026

(54) FEDERATED STATISTICAL AND TRAFFIC FLOW ANALYSIS FOR ANOMALY DETECTION IN A CLOUD ENVIRONMENT

(71) Applicant: Oracle International Corporation, Redwood Shores, CA (US)

(72) Inventors: Kourosh Lashgari, Seattle, WA (US); Ravi Shankar Kamaraj, Karnataka (IN)

(73) Assignee: Oracle International Corporation, Redwood Shores, CA (US)

(21) Appl. No.: 18/958,390

(22) Filed: Nov. 25, 2024

(51) Int. Cl. H04L 41/22; G06F 3/0484

(52) U.S. Cl. CPC H04L 41/22; G06F 3/0484

(57) ABSTRACT

Techniques for federated statistical and traffic flow analysis for anomaly detection in a cloud environment are disclosed. A plurality of payloads are received from first one or more components of the cloud environment and at a gateway of the cloud environment. The plurality of payloads are destined for second one or more components of the cloud environment. One or more attributes of each of the plurality of payloads are determined. Based on the one or more attributes of each of the payloads, the plurality of payloads is divided into two or more groups. For each group, one or more statistical data are gathered, based on the corresponding subset of the plurality of payloads for the corresponding group. The statistical data are analyzed, to detect an anomalous issue with one group of the two or more groups. Information associated with the anomalous issue are displayed on a user interface.

### BACKGROUND

A cloud provider provides on-demand, scalable computing resources (e.g., a cloud environment) to its cloud customers. A cloud customer generally desires to run its cloud resources without monitoring, scanning, or other interference by the cloud provider or other cloud customer. Therefore, the cloud provider offers “tenancies” to its cloud customers. A tenancy is an isolated partition within the cloud environment, such that resources in different tenancies are isolated from each other unless explicitly shared. Each tenancy runs a plurality of virtual machine compute instances.

### BRIEF SUMMARY

In various embodiments, a non-transitory computer-readable medium includes instructions that when executed by one or more processors, cause a system including the one or more processors to perform operations including: receiving, at a gateway of a cloud environment and during a first time-window, a plurality of payloads from first one or more components of a first section of the cloud environment, wherein the plurality of payloads are destined for second one or more components of a second section of the cloud environment; determining one or more attributes of each of the plurality of payloads; based at least in part on the one or more attributes of each of the payloads, dividing the plurality of payloads into two or more groups, such that each group includes a corresponding subset of the plurality of payloads; for each group of the two or more groups, gathering one or more statistical data based on the corresponding subset of the plurality of payloads for the corresponding group; analyzing the one or more statistical data, to detect an anomalous issue with at least one group of the two or more groups; and causing to display, on a user interface, information associated with the anomalous issue. In an example, the operations include: receiving, at the gateway of the cloud environment and during a second time-window that occurs subsequent to the first time-window, another plurality of payloads from the first one or more components of the first section of the cloud environment, wherein the other plurality of payloads are destined for the second one or more components of the second section of the cloud environment; determining one or more attributes of each of the other plurality of payloads; dividing the other plurality of payloads into another two or more groups, such that each group of the other two or more groups includes a corresponding subset of the other plurality of payloads; for each group of the other two or more groups, gathering another one or more statistical data based on the corresponding subset of the other plurality of payloads for the corresponding group; analyzing the other one or more statistical data, to detect another anomalous issue with at least another group of the other two or more groups; and causing to display, on the user interface, information associated with the other anomalous issue.

In an example, dividing the plurality of payloads into two or more groups comprises: accessing a plurality of flow keys, each flow key associated with corresponding one or more attribute values; in response to one or more attributes of a first payload of the plurality of payloads matching at least corresponding one or more attribute values of a first flow key, grouping the first payload to a first group associated with the first flow key; and in response to one or more attributes of a second payload of the plurality of payloads matching at least corresponding one or more attribute values of a second flow key, grouping the first payload to a second group associated with the second flow key. In an example, the first flow key is associated with (i) a first attribute value of a first attribute and (ii) a second attribute value of a second attribute; the second flow key is associated with (i) a third attribute value of the first attribute and (ii) a fourth attribute value of the second attribute; the one or more attributes of the first payload matches with the first attribute value of the first attribute and the second attribute value of the second attribute; and the one or more attributes of the second payload matches with the third attribute value of the first attribute and the fourth attribute value of the second attribute. In an example, the plurality of payloads is a first plurality of payloads, and wherein the operations include: analyzing a second plurality of payloads; and defining a first flow key of the plurality of flow keys, based at least in part on analyzing the second plurality of payloads. In an example, defining the first flow key of the plurality of flow keys comprises: analyzing a data structure and/or metadata of one or more of the second plurality of payloads; based at least in part on analyzing a data structure and/or metadata of one or more of the second plurality of payloads, determining that one or more payloads of the second plurality of payloads includes a first attribute value of a first attribute, wherein no currently defined flow key is associated with the first attribute value of the first attribute; and defining the first flow key that is associated with at least the first attribute value of the first attribute. In an example, the first flow key is associated with a combination of at least (i) the first attribute value of the first attribute and (ii) a second attribute value of a second attribute. In an example, the one or more statistical data for each group and for each of a plurality of time windows are stored within a storage repository; the operations include adaptively updating a number of flow keys within the plurality of flow keys, based at least in part on an available storage capacity and/or a total storage capacity of the storage repository; and adaptively updating the number of flow keys comprises adding one or more flow keys to the plurality of flow keys, or deleting one or more flow keys from the plurality of flow keys.

In an example, the one or more statistical data comprises at least one of a mean, a count, a median, a standard deviation, an error count, and a z-score. In an example, the first section of the cloud environment is within a first tenancy of the cloud environment; the second section of the cloud environment is within a second tenancy of the cloud environment that is different from the first tenancy; and the gateway is within a third tenancy of the cloud environment that is different from each of the first tenancy and the second tenancy. In an example, the first tenancy and the second tenancy are rented out to a same cloud customer of the cloud environment. In an example, the third tenancy is operated by an assurance administrator responsible for regulating one or more operations of the cloud customer within the cloud environment. In an example, the first section of the cloud environment is within a first cloud region of a first tenancy of the cloud environment; the second section of the cloud environment is within a second cloud region of the first tenancy of the cloud environment; and the gateway is within a second tenancy of the cloud environment that is different from the first tenancy.

In an example, a method comprises: receiving, at a gateway of a cloud environment and during a first time-window, a plurality of payloads from first one or more components of a first section of the cloud environment, wherein the plurality of payloads are destined for second one or more components of a second section of the cloud environment; determining one or more attributes of each of the plurality of payloads; based at least in part on the one or more attributes of each of the payloads, dividing the plurality of payloads into two or more groups, such that each group includes a corresponding subset of the plurality of payloads; for each group of the two or more groups, gathering one or more statistical data based on the corresponding subset of the plurality of payloads for the corresponding group; analyzing the one or more statistical data, to detect an anomalous issue with at least one group of the two or more groups; and causing to display, on a user interface, information associated with the anomalous issue. In an example, the method further comprises: receiving, at the gateway of the cloud environment and during a second time-window that occurs subsequent to the first time-window, another plurality of payloads from the first one or more components of the first section of the cloud environment, wherein the other plurality of payloads are destined for the second one or more components of the second section of the cloud environment; determining one or more attributes of each of the other plurality of payloads; dividing the other plurality of payloads into another two or more groups, such that each group of the other two or more groups includes a corresponding subset of the other plurality of payloads; for each group of the other two or more groups, gathering another one or more statistical data based on the corresponding subset of the other plurality of payloads for the corresponding group; analyzing the other one or more statistical data, to detect another anomalous issue with at least another group of the other two or more groups; and causing to display, on the user interface, information associated with the other anomalous issue. In an example, dividing the plurality of payloads into two or more groups comprises: accessing a plurality of flow keys, each flow key associated with corresponding one or more attribute values; in response to one or more attributes of a first payload of the plurality of payloads matching at least corresponding one or more attribute values of a first flow key, grouping the first payload to a first group associated with the first flow key; and in response to one or more attributes of a second payload of the plurality of payloads matching at least corresponding one or more attribute values of a second flow key, grouping the first payload to a second group associated with the second flow key. In an example, the one or more statistical data for each group and for each of a plurality of time windows are stored within a storage repository; the method further comprises adaptively updating a number of flow keys within the plurality of flow keys, based at least in part on an available storage capacity and/or a total storage capacity of the storage repository; and adaptively updating the number of flow keys comprises adding one or more flow keys to the plurality of flow keys, or deleting one or more flow keys from the plurality of flow keys. In an example, the first section of the cloud environment is within a first tenancy of the cloud environment; the gateway is within a second tenancy of the cloud environment that is different from the first tenancy; and the second section of the cloud environment is within one of (i) the first tenancy, or (ii) a third tenancy of the cloud environment that is different from the first tenancy and the second tenancy.

In various embodiments, a system comprises: one or more processors; a storage repository; and one or more non-transitory computer-readable media storing instructions, which, when executed by the system, cause the system to perform operations including: receiving, at a gateway of a cloud environment and during a first time-window, a plurality of payloads from first one or more components of a first section of the cloud environment, wherein the plurality of payloads are destined for second one or more components of a second section of the cloud environment; determining one or more attributes of each of the plurality of payloads; based at least in part on the one or more attributes of each of the payloads, dividing the plurality of payloads into two or more groups, such that each group includes a corresponding subset of the plurality of payloads; for each group of the two or more groups, gathering one or more statistical data based on the corresponding subset of the plurality of payloads for the corresponding group; analyzing the one or more statistical data, to detect an anomalous issue with at least one group of the two or more groups; and causing to display, on a user interface, information associated with the anomalous issue. In an example, the first section of the cloud environment is within a first tenancy of the cloud environment; the gateway is within a second tenancy of the cloud environment that is different from the first tenancy; and the second section of the cloud environment is within one of (i) the first tenancy, or (ii) a third tenancy of the cloud environment that is different from the first tenancy and the second tenancy.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a block diagram of a cloud environment comprising (i) a first cloud section, (ii) a second cloud section, and (iii) an assurance administrator tenancy, wherein a plurality of payloads are transmitted between the first cloud section and the second cloud section through the assurance administrator tenancy, wherein the transmitted payloads are intercepted by an assurance proxy of the assurance administrator tenancy, and wherein the intercepted payloads are audited for federated statistical data collection and traffic flow analysis, to enable detection of anomalous issues with the traffic flow.

FIG. 2 illustrates a first cloud section and a second cloud section being in a same customer tenancy, and in two different cloud regions of a cloud environment.

FIG. 3 illustrates a first cloud section and a second cloud section being in a first customer tenancy and a second customer tenancy, respectively, of a cloud environment.

FIG. 4A illustrates a plurality of payloads transmitted through an assurance proxy during various time windows.

FIG. 4B illustrates a flow key management service, a payload division service, and an analysis service within an assurance proxy of a cloud environment.

FIG. 5 illustrates a data flow diagram depicting federated statistical and traffic flow analysis, and anomaly detection for traffic flow passing through an assurance proxy of an assurance administrator tenancy.

FIG. 6 illustrates processing of a request and a response by an assurance proxy of a cloud environment.

FIG. 7A illustrates a flowchart depicting a method for defining new flow keys, based on monitoring payloads processed by an assurance proxy of a cloud environment.

FIG. 7B illustrates a flowchart depicting a method for federated statistical and traffic flow analysis, and anomaly detection for traffic flow passing through an assurance proxy of an assurance administrator tenancy of a cloud environment.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

Maintaining security of a cloud environment involves controlling access to cloud resources based on permissions specified by respective cloud customers. A cloud customer can grant permissions for accessing cloud resources that it rents, but the cloud customer should not be able to grant permissions for accessing cloud resources rented by other customers. A tenancy is a conceptual bucket that holds cloud resources belonging to a particular cloud customer. An administrator of a tenancy has administrative rights to set access policies for cloud resources in the tenancy; an administrator of a tenancy does not have administrative rights to set access policies for cloud resources in another tenancy. A tenancy of a cloud customer is isolated from another tenancy of another cloud customer. A tenancy of a cloud customer includes a plurality of active cloud resources, such as compute instances that are used to host virtual machines. The cloud provider may also have control on one or more tenancies (e.g., cloud provider tenancies), through which the cloud provider may provide one or more services to the cloud customers.

A cloud provider may provide a cloud environment over a number of geographical areas. For example, a cloud environment may span across multiple cities, multiple states, multiple countries, and/or over even multiple continents. A portion of the cloud environment within a specific geographical area (such as a city, or a state, or a country) is referred to as a cloud region. Thus, the cloud environment may span a plurality of such cloud regions. A cloud region may encompass cloud resources within a city, a state, a country, or another appropriate geographical area whose boundary is defined by the cloud provider.

A “cloud section” (or simply a “section”) of a cloud environment, as referred to herein, refers to a specific tenancy, a portion of a tenancy within a cloud region, or another portion of the cloud environment. Thus, in an example, a reference to a first cloud section and a second cloud section of a cloud environment may imply a first tenancy and a second tenancy, respectively, within a cloud environment. In another example, a reference to a first cloud section may imply a first portion of a tenancy, and a reference to a second cloud section may imply a second portion of the tenancy, wherein the first portion of the tenancy is within a first cloud region, and wherein the second portion of the tenancy is within a second cloud region of the cloud environment.

As described below in further detail, a cloud customer may want to transmit data between a first cloud section and a second cloud section of a cloud environment. In an example, both the first cloud section and the second cloud section of the cloud environment may be rented out to a same cloud customer (or to two different subsidiaries of the same cloud customer). As discussed, in an example, the two cloud sections may be two different tenancies rented out to the same cloud customer. In another example, the two cloud sections may be part of a same tenancy rented out to a cloud customer, but located in two different cloud regions of the cloud environment.

Generally, as the two cloud sections are rented out to the same cloud customer, the provider of the cloud environment and/or a third party may not monitor, intercept, and/or analyze the data communicated between the first cloud section and the second cloud section. However, in the cloud environment described herein, in the context of software assurance, an additional role of an assurance administrator is added into the picture. The assurance administrator may or may not be the same as the cloud provider. In an example, the assurance administrator acts as a “trusted technology provider” (TTP). It is assumed herein that the assurance administrator is the same as the cloud provider (the provider or owner of the cloud environment), although the teachings of this disclosure are not limited by such assumptions, and the assurance administrator may be different from the cloud provider.

With regard to the subject disclosure, in an example, the assurance administrator has a monitoring role over a manner in which the cloud customer is using the cloud resources. In an example, the assurance administrator may be tasked by a government regulatory agency to monitor operations of the cloud customer. As a part of such software assurance, the assurance administrator may want to intercept and/or audit the data communicated between the first cloud section and the second cloud section of the cloud customer.

For example, the first cloud section may be within a jurisdiction of a first governmental agency and the second cloud section may be within a jurisdiction of a second governmental agency, such as the first cloud section and the second cloud section being located in two different countries. Accordingly, the assurance administrator may want to ensure that the data transmitted is compliant with regulatory guidelines established by the one or both the countries. In another example where the first cloud section and the second cloud section are collocated, communication between the first and second cloud sections may be monitored, e.g., to ensure that the communication is in accordance with established guidelines.

In an example, accordingly, data transmission between the first section and the second section is routed through an assurance proxy within an assurance tenancy. The assurance tenancy, including the assurance proxy, is operated and maintained by personnel of the assurance administrator, in an example. The first section may include a plurality of first components and likewise, the second section may include a plurality of second components. The communication through the assurance proxy may be between any of the plurality of first components and any of the plurality of second components. In an example, during such communication, payloads are exchanged between the first section and the second section, through the assurance proxy.

In an example, a number of payloads being transmitted through the assurance proxy may be relatively large, such as tens of thousands, or hundreds of thousands, or even millions of payloads per second. Analyzing such a large number of payloads by the assurance proxy may be difficult, and may not produce useful results. For example, the traffic flow through the assurance proxy may be heterogeneous, and may not be correlated to each other. Merely as examples, first one or more payloads may be from a first cloud service of the first section to a first compute instance of the second section; second one or more payloads may be from a second compute instance of the second section to a storage repository of the first section; and so on. Accordingly, the nature, goal, origin, destination, and/or possible anomalous issues associated with the first one or more payloads may be different from those of the second one or more payloads. Analyzing a combination of the first one or more payloads and the second one or more payloads may not generate productive or useful results, due to the heterogenous nature of these payloads.

Accordingly, instead of analyzing the entire traffic flow passing through the assurance proxy as a whole, in an example, the assurance proxy divides the traffic flow passing through the assurance proxy into a plurality of strata or groups. For example, the assurance proxy defines or otherwise accesses a plurality of flow keys, where each flow key includes (or is associated with) one or more attribute values of the payloads. Based on the flow keys, the assurance proxy divides the traffic flow passing through the assurance proxy into the plurality of strata or groups. For example, payloads matching a first flow key are grouped in a first stratum, payloads matching a second flow key are grouped in a second stratum, and so on.

In an example, when intercepting and analyzing the traffic flowing through the assurance proxy, the assurance proxy divides the time into discrete time windows, and intercepts and analyzes the traffic flow for each such time window. For a given time window, once the payloads are divided in a plurality of strata, the assurance proxy analyzes payloads of each such stratum, and stores the resultant analysis information in a storage repository. Thus, instead of analyzing the whole traffic flow of all the heterogenous payloads passing through the assurance proxy, the assurance proxy divides the payloads into strata, and analyzes individual group or stratum of payloads. Such divide and analysis approach provides more meaningful analysis results, as relevant and somewhat associated payloads (e.g., payloads of homogenous nature) are grouped in a same stratum. For example, although the overall traffic flowing through the assurance proxy may be heterogenous in nature, subdividing the traffic in a plurality of strata or groups results in each group including relatively homogenous payloads. Merely as an example, payloads having a specific origin and a specific target may be grouped in a single stratum (e.g., assuming that the flow keys are defined in such a manner). Analysis of such relevant and somewhat associated payloads (e.g., relatively homogenous payloads) provide more meaningful information about the payloads within the stratum. In an example, this multi-layered or multi-strata analysis allows for a granular inspection of traffic flows, thereby identifying subtle anomalies within each stratum, which may be missed by analyzing the traffic flow as a whole (e.g., without dividing the traffic flow), as described below in further detail.

As will be described below in further detail, the division of the payloads in a plurality of strata is based on a corresponding plurality of flow keys. One or more flow keys may be adaptively generated or defined, based on analyzing the payloads, whereas one or more other flow keys may be predefined (e.g., by a human operator). Details of adaptively generating and/or updating the flow keys, and examples of such flow keys are described below in further detail.

For a given time window, once the payloads are divided in a plurality of strata, the assurance proxy analyzes payloads of each such stratum, and stores the resultant information in a storage repository. For each stratum and for each time window, the resultant information includes one or more statistical metrics (e.g., counts, mean, median, standard deviation, error counts, z-scores, etc.).

For each stratum and for each time window, the resultant statistical information are stored in a storage repository. Subsequently, an anomaly detection service analyzes the statistical information, to possibly detect anomalous issues with none, one, or more strata and for none, one, or more time-windows, as described below in further detail.

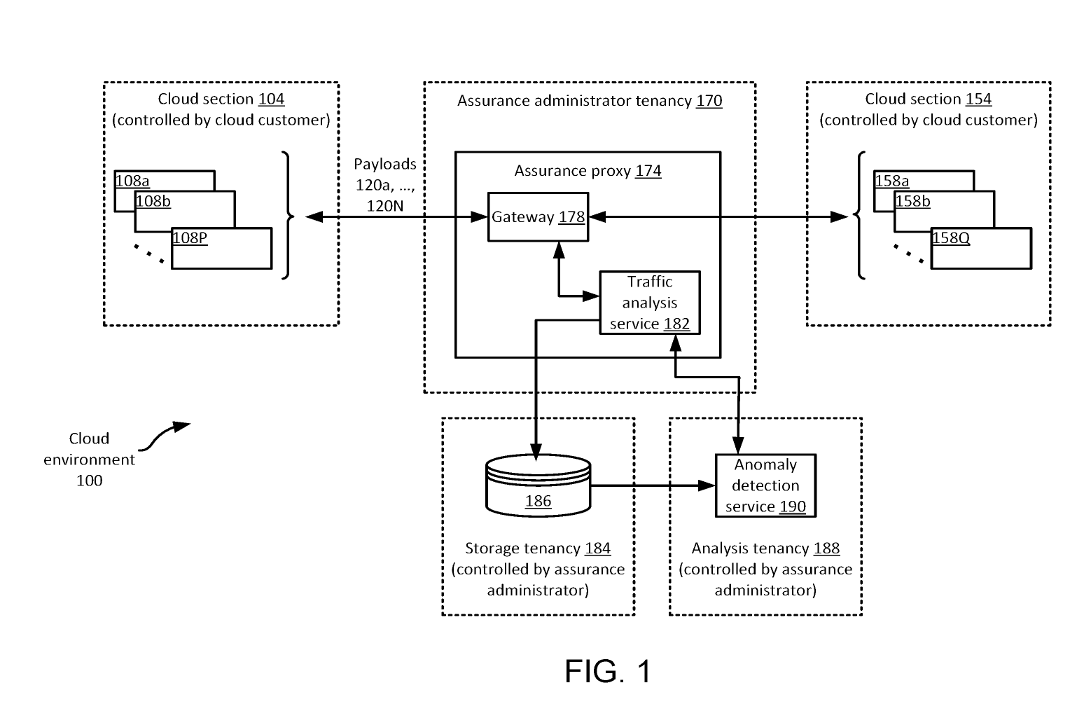

FIG. 1 illustrates a block diagram of a cloud environment 100 comprising (i) a first cloud section 104 (also henceforth referred to herein as a section 104), (ii) a second cloud section 154 (also henceforth referred to herein as a section 154), and (iii) an assurance administrator tenancy 174, wherein a plurality of payloads 120a, …, 120N are transmitted between the first cloud section 104 and the second cloud section 154 through the assurance administrator tenancy 174, wherein the transmitted payloads 120 are intercepted by an assurance proxy 174 of the assurance administrator tenancy 170, and wherein the intercepted payloads are audited for federated statistical data collection and traffic flow analysis, to enable detection of anomalous issues with the traffic flow.

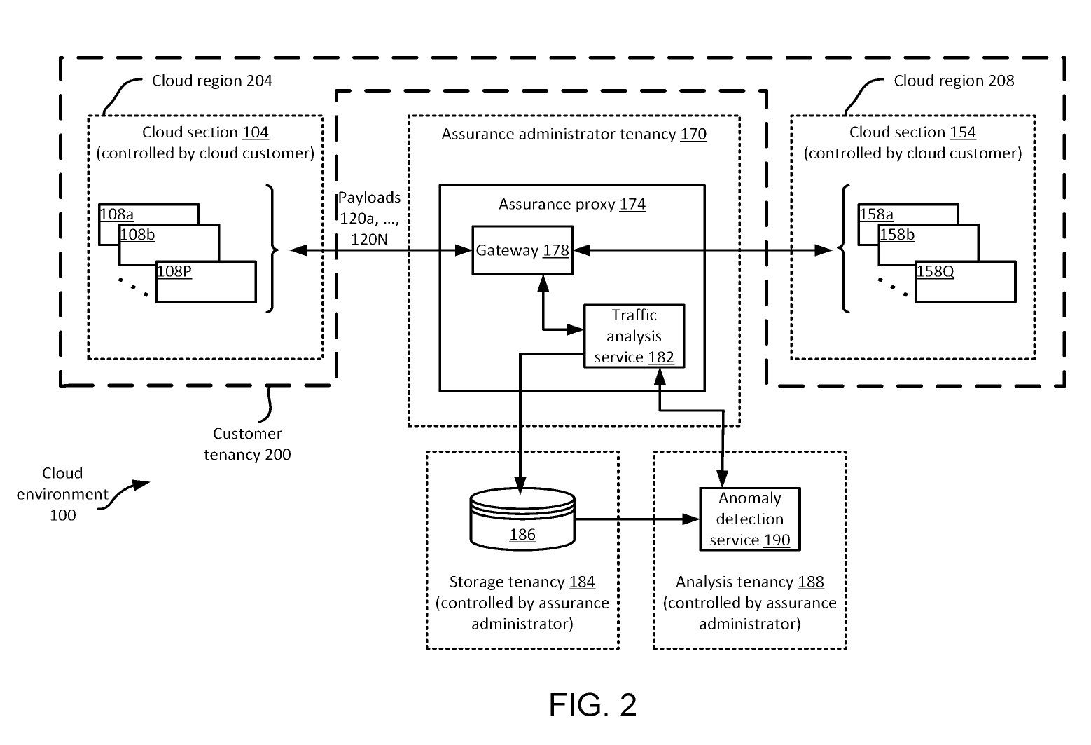

As described above, in an example, each of the sections 104, 154 may represent a respective tenancy, or a portion of a tenancy. For example, FIG. 2 illustrates a first cloud section 104 and a second cloud section 154 of FIG. 1 being in a same customer tenancy 200, and in two different cloud regions 204 and 208 of the cloud environment 100. For example, the cloud region 204 including the section 104 and the cloud region 208 including the section 154 may be geographically apart from each other, e.g., in two different cities, in two different states of a country, in two different countries, or even in two different continents.

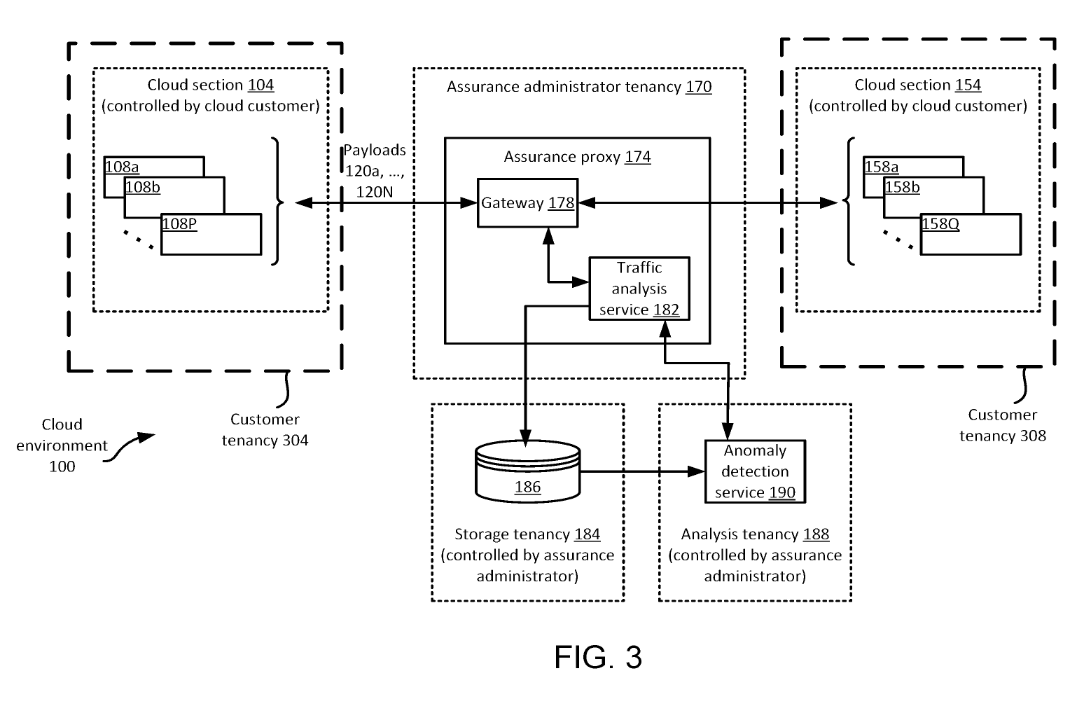

FIG. 3, on the other hand, illustrates a first cloud section 104 and a second cloud section 154 of FIG. 1 being in a first customer tenancy 304 and a second customer tenancy 308, respectively, of the cloud environment 100. Thus, in this example, the two sections 104 and 154 are in two different tenancies 304 and 308. In an example, the two tenancy 304 and 308 may be rented out to a same cloud customer. In an example, the tenancies 304 and 308 may be geographically apart from each other, e.g., in two different cities, in two different states, in two different countries, or even in two different continents, although in another example the two tenancies 304 and 308 may be geographically collocated.

For the example of FIGS. 2 and/or 3, the assurance administrator tenancy 170 (such as an assurance proxy 174 within the assurance administrator tenancy 170) may be located proximal to the section 104 (such as within a same cloud region as the section 104), or may be located proximal to the section 154 (such as within a same cloud region as the section 154), or may be located proximal to both the sections 104 and 154 (such as sections 104, 154, and assurance administrator tenancy 170 being collocated in a same geographical region), or may not be located proximal to either of the sections 104, 154 (such as within a cloud region that is different from the cloud region including the section 104 and/or different from the cloud region including the section 104). The location of the assurance tenancy 170 relative to the sections 104, 154 is implementation specific, and may vary from one implementation to the next, in an example.

Referring again to FIG. 1, in an example, the two sections 104, 154 may be rented out by the provider of the cloud environment 100 to a same cloud customer (or to two different subsidiaries of the same cloud customer). The two sections 104 and 154 communicate and transmit a plurality of payloads 120a, …, 120N (such as messages, requests, response, data, or other information) among themselves, via the assurance administrator tenancy 170.

In an example, each of the sections 104, 154 may operate a plurality of cloud services and/or may include a plurality of cloud resources. Illustrated in FIG. 1 are components 108a, 108b, …, 108P within the section 104, and components 158a, 158b, …, 158Q within the section 104. Each component 108 or 158 represents a cloud service, a compute instance, or a cloud resource within the corresponding section 104 or 154 within the cloud environment 100.

As described above, each of the payloads 120a, …, 120N is transmitted between (i) a corresponding one of the components 108a, …, 108P of the section 104 and (ii) a corresponding one of the components 158a, …, 158Q of the section 154. Merely as examples, the payload 120a may be transmitted from component 108a to component 158b (or from component 158b to component 108a); the payload 120b may be transmitted from component 108c to component 158b (or from component 158b to component 108c), and so on.

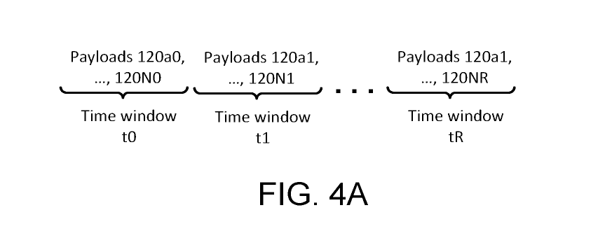

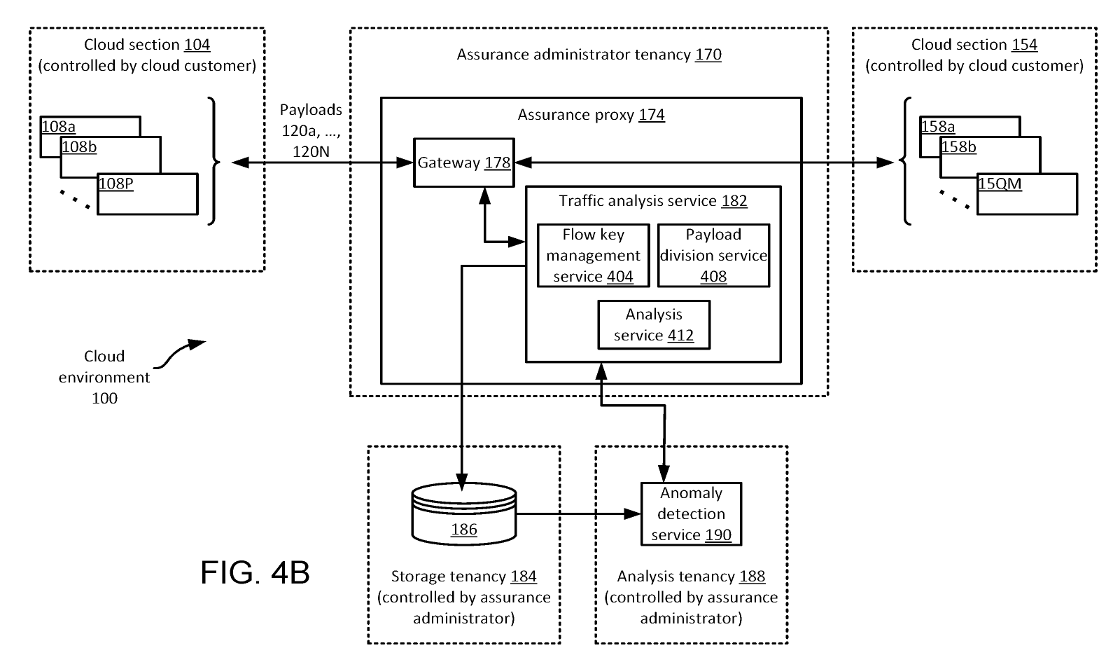

FIG. 4A illustrates a plurality of payloads 120a0, …, 120NR transmitted through the assurance proxy of FIGS. 1-3 during various time windows t0, …, tR. For example, when intercepting and analyzing the traffic flowing through the assurance proxy 174, the assurance proxy 174 divides the time into discrete time windows, and intercepts and analyzes the traffic flow based on such time windows. Example time windows t0, …, tR are illustrated in FIG. 4A, with example payloads transmitted during each such time window. For example, payloads 120a0, 120b0, …, 120N0 are received by the assurance proxy 174 at time window t0; payloads 120a1, 120b1, …, 120N1 are received by the assurance proxy 174 at time window t1, and so on.

A duration of a time window may be configurable. For example, each time window t0, …, tR may range from a fraction of a second, or a few seconds, to a few minutes, as will be described below in further detail. In an example, the duration of the time window may be dynamically adjusted, e.g., based on an available memory capacity, a desired resolution of anomaly detection, and/or the like, as described below in further detail.

Referring again to FIG. 1, generally, when two sections 104 and 154 of the cloud environment 100 (which are rented to a same cloud customer) communicate among themselves, the provider of the cloud environment and/or a third party may not intercept and/or analyze the payloads communicated between the sections 104, 154. However, in the cloud environment 100, in the context of software assurance, an additional role of the assurance administrator is added into the picture. The assurance administrator may or may not be the same as the cloud provider. In an example, the assurance administrator acts as trusted technology provider (TTP). In an example, the assurance administrator has a monitoring role over payload transmission between the two sections 104, 154. In an example, the assurance administrator may be tasked by a government regulatory agency and/or by another third party to monitor and/or regulate one or more aspects of operations of the cloud customer, including communication between the sections 104 and 154. As a part of such software assurance, the assurance administrator may want to intercept and/or audit the payloads 120a, …, 120N communicated between the sections 104, 154.

Merely as an example, the assurance administrator may want to ensure that the payloads 120a, …, 120N transmitted between the cloud sections 104, 154 do not include non-permissible information, such as malicious data, sensitive data, personally identifiable information of one or more users of one or more services offered by the cloud customer, and/or the like. For example, the assurance administrator may want to ensure that such prohibited or non-permissible payloads are not transmitted across section boundaries (such as across country boundaries, or across tenancy boundaries). In an example, the assurance administrator analyzes the transmitted payloads 120a, …, 120N, such as performs statistical analysis of the payloads, and traffic flow analysis of the traffic flow between the sections 104, 154.

Accordingly, the assurance administrator tenancy 170 (e.g., which is operated by personnel of the assurance administrator) includes an assurance proxy 174, which receives payloads from the section 104 and transmits to the section 154, and/or receives payloads from the section 154 and transmits to the section 104. Thus, the assurance proxy 174 of the assurance administrator tenancy 170 intercepts the payloads transmitted between the sections 104, 154, and analyzes the intercepted payloads.

In an example, the assurance proxy 174 of the assurance administrator tenancy 170 includes a gateway 178, which receives payloads from one of the sections 104, 154, processes the payloads, and transmits the payloads to the other of the sections 104, 154, In an example, processing the payloads include transmitting the payloads 120a, …, 120N (or copies of the payloads) to a traffic analysis service 182 operating with the assurance administrator tenancy 170 (such as within the assurance proxy 174). Thus, payloads 120a, …, 120N transmitted through the assurance proxy 172 are accessed by the traffic analysis service 182.

The traffic analysis service 182 analyzes the payloads 120a, …, 120N, and stores information associated with the payloads 120a, …, 120N within a storage repository 186. The storage repository 186 may be within the assurance administrator tenancy 170, or may be within a separate storage tenancy 184 that is controlled by the assurance administrator. The information stored within the storage repository 186 may include statistical information about the flow of traffic through the assurance proxy 174, one or more metrics associated with the flow of traffic through the assurance proxy 174, and/or other relevant information associated with the flow of traffic through the assurance proxy 174. In an example, an anomaly detection service 190 analyzes the information stored within the storage repository 186, aiming to detect one or more anomalous issues with the traffic flow through the assurance proxy 174.

In an example, a number of payloads being transmitted through the assurance proxy 174 may be relatively large, such as tens of thousands, or hundreds of thousands, or even millions of payloads per second. Analyzing such a large number of payloads by the traffic analysis service 182 and/or the anomaly detection service 190 may be difficult, and may not produce useful results. For example, the traffic flow through the assurance proxy 174 may be heterogeneous, and may not be correlated to each other. Merely as examples, first one or more payloads may be from a service 108a, second one or more payloads may be from a compute instance 108b, a third one or more payloads may be from another type of clod resource 108c, and/or the like. Accordingly, the nature, goal, origin, destination, and/or possible anomalous issues associated with the first one or more payloads may be different from those of the second one or more payloads or from the third one or more payloads. Analyzing a combination of the first one or more payloads, the second one or more payloads, and/or the third one or more payloads may not generate productive or useful results, due to the heterogenous nature of these payloads.

Accordingly, during each time period (such as time periods t0, t1, …, see FIG. 4A), the traffic analysis service 182 and/or the gateway 178 divide the traffic flow passing through the assurance proxy 174 into a plurality of strata or groups. For example, the traffic analysis service 182 (or the gateway 178) defines or otherwise accesses a plurality of flow keys, where each flow key includes (or is associated with) one or more attribute values of the payloads. Based on the flow keys, the traffic analysis service 182 and/or the gateway 178 divide the traffic flow passing through the assurance proxy 174 into the plurality of strata or groups. For example, payloads matching a first flow key are grouped in a first stratum, payloads matching a second flow key are grouped in a second stratum, and so on.

For a given time window, once the payloads are divided in a plurality of strata, the traffic analysis service 182 analyzes payloads of each such stratum, and stores the resultant information in the storage repository 186. Thus, instead of analyzing the whole traffic flow of all the heterogenous payloads passing through the assurance proxy 174, the traffic analysis service 182 divides the payloads into strata, and analyzes individual group or stratum of payloads. Such divide and analysis approach provides more meaningful analysis results, as relevant and somewhat associated payloads (e.g., payloads of homogenous nature) are grouped in a same stratum. For example, although the overall traffic flowing through the assurance proxy 174 may be heterogenous in nature, subdividing the traffic in a plurality of strata or groups results in each group including relatively homogenous payloads. Merely as an example, payloads having a common origin and common target may be grouped in a single stratum (e.g., assuming that the flow keys are defined in such a manner). Analysis of such relevant and somewhat associated payloads (e.g., relatively homogenous payloads) provide more meaningful information about the payloads within the stratum. This multi-layered or multi-strata analysis allows for a granular inspection of traffic flows, identifying subtle anomalies within each stratum, which may be missed by analyzing the traffic flow as a whole (e.g., without dividing the traffic flow).

FIG. 4B illustrates a flow key management service 404, a payload division service 408, and an analysis service 412 within an assurance proxy 174 of a cloud environment. Note that although all these components are illustrated to be within the traffic analysis service 182, one or more of these components may be within the gateway 178 as well.

For example, the payload division service 408 divides the payload traffic passing through the assurance proxy 174 into the above-described plurality of strata, based on the corresponding plurality of flow keys. The analysis service 412 analyzes payloads of individual stratum, e.g., to generate the statistical information for each stratum. The flow key management service 404 manages (such as stores, defines, maintains, etc.) the flow keys. Each of these components are described below in further detail.

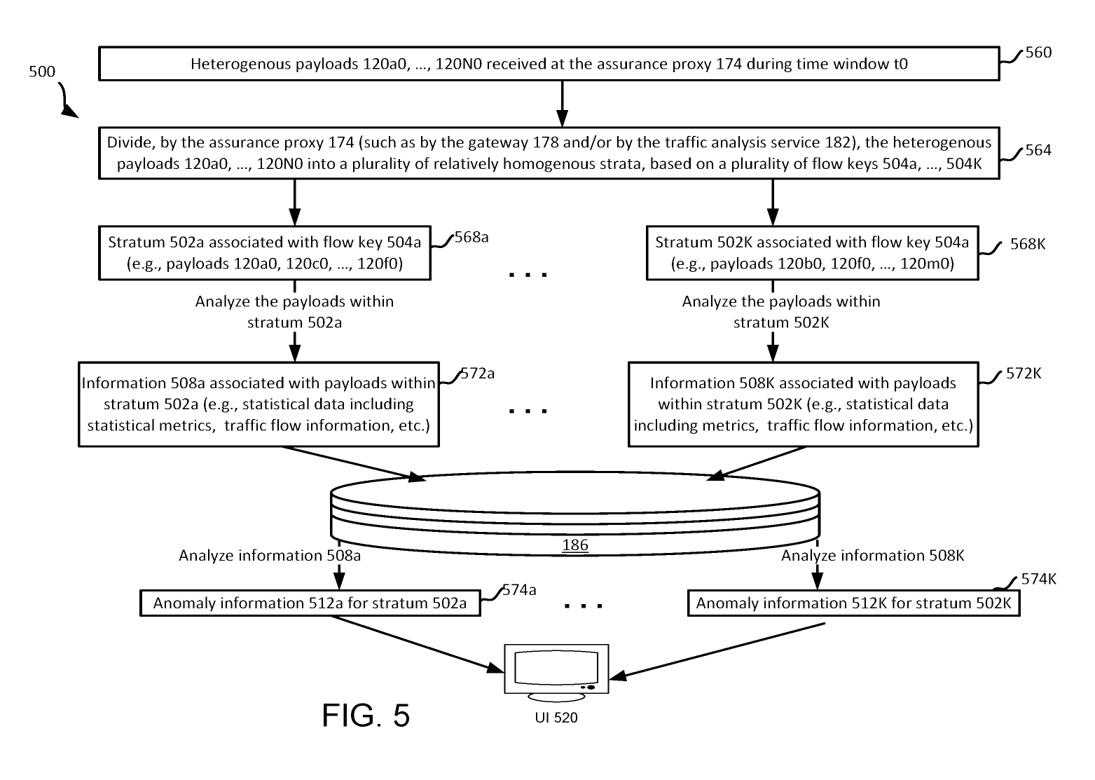

FIG. 5 illustrates a data flow diagram 500 depicting federated statistical and traffic flow analysis, and anomaly detection for traffic flow passing through the assurance proxy 174 of the assurance administrator tenancy 170 of FIGS. 1-3.

FIG. 5 is for a specific time window t0 (see FIG. 4A for time windows). Similar flow diagrams may be possible for other time windows, such as time window t1, t2, …, tR, and so on.

At 560 of the flow diagram 500, the assurance proxy 174 receives heterogenous payloads 120a0, …, 120N0 (also see FIG. 4A) that are received by the assurance proxy 174 during the time window t0.

At 564, the assurance proxy 174 (e.g., the gateway 178 and/or the traffic analysis service 182, such as the payload division service 408 of FIG. 4B) divides the relatively heterogenous payloads 120a0, …, 120N0 into a plurality of relatively homogenous strata or groups 502a, 502b, …, 502K, based on a corresponding plurality of flow keys 504a, 504b, …, 504K. Each flow key 504 is associated with a corresponding stratum, such that payloads matching the flow key are grouped in the corresponding stratum. Example stratum 502a associated with a flow key 504a (which includes example payloads 120a0, 120c0, …, 120f0) is illustrated within box 568a; example stratum 502K associated with a flow key 504K (which includes example payloads 120b0, 120f0, …, 120m0) is illustrated within box 568K, and so on.

Subsequently, payloads within individual stratum are analyzed by the assurance proxy 174, such as by the gateway 178 and/or by the traffic analysis service 182 (e.g., symbolically illustrated using the arrows between boxes 568a, 572a, and between boxes 568K, 572K), to generate corresponding information 508. In an example, the above-described analysis service 412 of FIG. 4B performs the analysis. For example, information 508a is generated based on analyzing payloads of stratum 502a, information 508b is generated based on analyzing payloads of stratum 502b, information 508K is generated based on analyzing payloads of stratum 502K, and so on.

The information 508a, …, 508K are stored in the storage repository 186, as illustrated in FIG. 5. Subsequently, the anomaly detection service 190 analyzes each of the information 508a, …, 508K, to possibly detect anomalous issues with none, or one, or more strata 502a, …, 502K. For example, if anomalous issues are detected with the information 512a, then the payloads associated with the stratum 502a may be anomalous. Subsequently, anomalous issues, if detected, are caused (e.g., by the anomaly detection service 190) to be displayed on a user interface (UI) 520, as illustrated in FIG. 5.

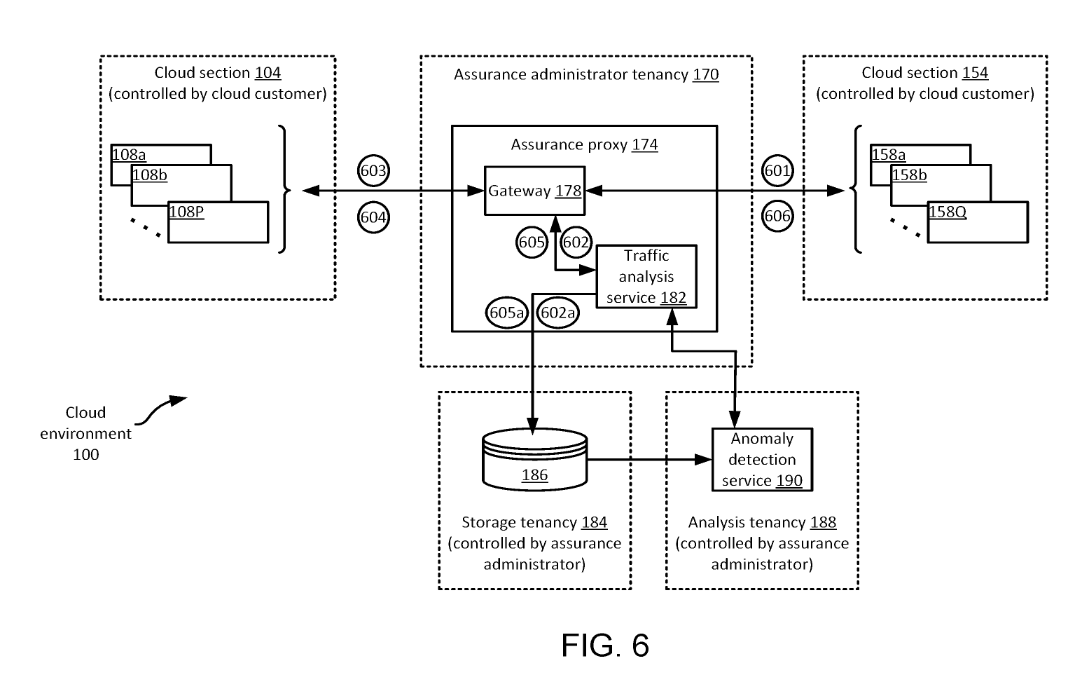

FIG. 6 illustrates processing of a request and a response by an assurance proxy 174 of the cloud environment 100 of FIGS. 1-4B. In FIG. 6, a component 158 (such as a component 158a) within the section 154 transmits a request to a component 108 (such as a component 108a) within the section 104, through the assurance proxy 174. In response, the component 108a transmits a response to the component 158a through the assurance proxy 174. The assurance proxy 174 processes both the request and the response.

Initially, at 601, the component 158a within the section 154 transmits a request to the assurance proxy 174, where an intended final destination of the request is the component 108a. The request is received by the gateway 178. The request may include one or more payloads. A payload may include one or more data packets and/or bits of data.

At 602, the gateway 178 passes the request to the traffic analysis service 182. Note that in an example, the gateway 178 may group the request to a specific stratum or group (e.g., as discussed with respect to FIG. 5). In another example, the traffic analysis service 182 may group the request to the specific stratum or group.

At 602a, the traffic analysis service 182 generates information 508 associated with the payloads within the stratum, where the payloads within the stratum includes the payload(s) associated with the request. Although not illustrated in FIG. 5, the anomaly detection service 190 later analyzes the information 508, e.g., to possibly detect anomalous issues with the payloads of the stratum.

At 603, the assurance proxy 174 forwards the processed request to its intended destination, which is the component 108a within the cloud section 104, for example. At 604, the component 108a within the cloud section 104 transmits a response destined for the component 158a of the section 154. The response is intercepted by the gateway 178. The response may include corresponding one or more payloads.

At 605, the gateway 178 passes the response to the traffic analysis service 182. Note that in an example, the gateway 178 may group the payload(s) of response to a specific stratum or group (e.g., as discussed with respect to FIG. 5). In another example, the traffic analysis service 182 may group the payload(s) of the response to the specific stratum or group.

At 605a, the traffic analysis service 182 generates other information 508 associated with the payloads within the stratum, where the payloads within the stratum includes the payload(s) associated with the response. Although not illustrated in FIG. 5, the anomaly detection service 190 later analyzes the other information 508, e.g., to possibly detect anomalous issues with the payloads of the stratum. At 606, the assurance proxy 174 forwards the processed response to its intended destination, which is the component 158a within the cloud section 154, for example.

Referring again to FIGS. 1-6, as described above, during each time period (such as time periods t0, t1, …, see FIG. 4A), the traffic analysis service 182 and/or the gateway 178 (such as the payload division service 408) divide the traffic flow passing through the assurance proxy 174 into a plurality of strata, e.g., based on a plurality of flow keys. For example, the traffic analysis service 182 (such as the flow key management service 404) accesses and/or defines a plurality of flow keys, where each flow key includes or otherwise is associated with one or more attribute values of payloads. Based on the flow keys, the traffic analysis service 182 and/or the gateway 178 (such as the payload division service 408) divide the traffic flow passing through the assurance proxy 174 into the plurality of strata. For example, payloads matching a first flow key is grouped in a first group, payloads matching a second flow key is grouped in a second group, and so on.

In an example, a flow key includes or is otherwise associated with one or more attribute values of corresponding one or more attributes of payloads of the traffic flowing through the assurance administrator tenancy 170. Examples of such attributes include an origin or source of a payload, a target destination of the payload, a user identification (ID) associated with the payload, a schema ID associated with the payload, an URL (uniform resource locator) defining a path associated with the payload, a channel ID associated with the payload, a business domain associated with the payload, a type of a request or a response including the payload, endpoints of the payload, and/or the like.

An “attribute value” implies a value of an attribute. As a simple example, flow keys may be associated with attribute values of an attribute of the payloads, where the attribute may be an origin of payloads. In this simple example, origin of the payloads can be component 158a, or 158b, or 108a, or 108b, which are possible attribute values. Accordingly, for this simple example, a first flow key is associated with component 158a being the origin of the payloads, a second flow key is associated with component 158b being the origin of the payloads, and so on.

In a further example, a first flow key may be for payloads originating from the component 158a and destined for the component 108a; a second flow key may be for payloads originating from the component 158a and destined for the component 108b; a third flow key may be for payloads originating from the component 158b and destined for the component 108c; and so on. Thus, in this example, the first, second, and third flow keys are defined by (source, destination) pair of a payload. Thus, the first flow key may be a combination of (i) an attribute value of component 158a as the originating component and (ii) an attribute value of component 108a as the destination component. Hence, a flow key may include (or may be defined by) a combination of one or more attribute values corresponding to one or more attributes of the payloads.

Note that the above-described first, second, and/or third flow keys can be further refined, to increase a granularity of dividing the traffic flow into strata. For example, for the above example, there are three strata corresponding to the three flow keys (e.g., a first flow key may be for payloads originating from the component 158a and destined for the component 108a; a second flow key may be for payloads originating from the component 158a and destined for the component 108b; a third flow key may be for payloads originating from the component 158b and destined for the component 108c). However, each flow key may be further refined to include an indication of whether the payload is generated from (or is associated with) a mobile application or a web browser of an end user. For example, the cloud customer may offer its service to its users via web browsers or mobile applications. Each of the above-described flow keys may be further split in two new flow keys, e.g., based on whether the payload is associated with the mobile application or the web browser. Accordingly, there might be six flow keys: (i) a first flow key for payloads originating from the component 158a, destined for the component 108a, and associated with mobile applications, (ii) a second flow key for payloads originating from the component 158a, destined for the component 108b, and associated with mobile applications, (iii) a third flow key for payloads originating from the component 158b, destined for the component 108c, and associated with mobile applications, (iv) a fourth flow key for payloads originating from the component 158a, destined for the component 108a, and associated with web browsers, (v) a fifth flow key for payloads originating from the component 158a, destined for the component 108b, and associated with web browsers, and (vi) a sixth flow key for payloads originating from the component 158b, destined for the component 108c, and associated with web browsers, for example. Note that these the flow keys are mere examples, and may vary from one implementation to the next.

Thus, increasing a number of flow keys (such as having more attribute values included in individual flow keys) results in a corresponding increase in a number of the strata. However, such an increase in the number of the strata may results in storing of statistical information 508 for each such stratum within the storage repository 186, which would consume higher amount of storage space of the storage repository 186. Accordingly, in an example, a number of the strata, and hence, a number of the flow keys may be limited by a total size of the storage repository 186 and/or an available size of the storage repository 186.

Additionally (or alternatively), processing and dividing payloads into a higher number of strata may also necessitate higher processing power of the gateway 178 and/or the traffic analysis service 182. Accordingly, in an example, a number of the strata, and hence, a number of the flow keys may be limited by a processing power available to the gateway 178 and/or the traffic analysis service 182.

In an example, once a payload arrives at the assurance proxy 175, the assurance proxy 175 (such as the gateway 178 and/or the traffic analysis service 182) parses the payload. For example, the assurance proxy 175 (such as the payload division service 408) reads a metadata of the payload, contents of the payload, data structure of the payload, and/or the like. Based on such information, the assurance proxy 175 (such as the gateway 178 and/or the traffic analysis service 182, e.g., the payload division service 408) matches the payload to a flow key, and groups the payload into a stratum corresponding to the flow key, as also described above with respect to FIG. 5.

Accordingly, a number of flow keys 504a, …, 504K (see FIG. 5 above) may be based on a number of factors, such as a total size of the storage repository 186, an available size of the storage repository 186, processing power available for the gateway 178 and/or the traffic analysis service 182, etc. In an example, the number of flow keys 504a, …, 504K may be adjusted dynamically, e.g., based on such factors. In some examples (but may not be for all examples), increasing a number of the flow keys 504a, …, 504K may yield more homogenous strata, but as described above, an upper limit on the number of the flow keys may be determined by one or more such factors.

As described above, the flow key management service 404 manages the flow keys 504a, …, 504K. In an example, one or more of the flow keys 504a, …, 504K may be provided by personnel of the assurance administrator. For example, the personnel of the assurance administrator may specify at least some (if not all) of the flow keys 504a, …, 504K to be used by the assurance proxy 174.

In an example, at least some of the flow keys 504a, …, 504Q may be dynamically and adaptively defined and/or updated by the assurance proxy 174 (such as by the gateway 178 and/or the traffic analysis service 182, e.g., by the flow key management service 404). For example, the flow key management service 404 reads metadata of the payloads received by the assurance proxy 174. In an example, the flow key management service 404 reads data structure of individual payloads received by the assurance proxy 174. In an example, based on such information, the flow key management service 404 generates and/or updates the flow keys.

For example, one or more fields or attributes of the data structure and/or metadata of the payloads are controlled by the cloud customer, and the cloud customer may update these attributes and/or possible values of these attributes (e.g., the attribute values) without coordinating with (or informing) the assurance administrator personnel. As an oversimplified example, assume that the cloud customer is initially offering its service to users of 10 geographical states of a country. Thus, the attribute “state” may have 10 possible attribute values (e.g., 10 possible values of the attribute “state”). Accordingly, a first flow key may be associated with a first value of this “state” attribute, a second flow key may be associated with a second value of this “state” attribute, and so on (note that each such flow key may also include one or more other attribute values as well). The first attribute value may be “Oregon” and the second value may be “California,” which are states of the United States, merely as examples. Now, assume that the cloud customer starts offering its service to an 11^{th} state of the country, which may be “Florida.” Resultantly, now some of the payloads will have “Florida” as its attribute value of this “state” attribute. The flow key management service 404 notices this new “Florida” attribute value of the “state” attribute, and adds one or more flow keys corresponding to this new “Florida” attribute value of the “state” attribute. Thus, in this example, the flow key management service 404 dynamically updates the flow keys, such as by detecting and adding one or more flow keys based on the new “Florida” attribute value of the “state” attribute added by the cloud customer.

In another example, assume that the cloud customer provides its service to a plurality of users having a corresponding plurality of user IDs. Each user ID has corresponding one or more flow keys. For example, a first user ID may have (i) a first flow key associated with traffic flow from a mobile application associated with the user ID, and (ii) a second flow key associated with traffic flow from a web browser in which the user ID is logged. Thus, in this example, each flow key may have two attribute values, such as a first attribute value for the user ID attribute and a second attribute value for the attribute associated with the medium (mobile application or web browser) used to access services offered by the cloud customer. As and when the cloud customer onboards new users having new user IDs, payloads associated with the new user IDs would be received by the assurance proxy 174. In an example, the flow key management service 404 reads the “user ID” field of each such payload. Upon detection of a new user ID for the “user ID” field, the flow key management service 404 generates or defines one or two new flow keys corresponding to each detected new user ID (e.g., one for the mobile application scenario, and another for the web browser scenario).

In the above discussed examples associated with the “state” attribute and the user ID attribute, the flow key management service 404 adds new attribute values for existing attributes. However, the cloud customer may detect an entirely new attribute or field in the metadata or data structure of one or more payloads. For example, assume previously only a “state’ attribute was used to geographically locate users of the cloud customer. However, the cloud customer has started monitoring a zip code of the users as well. Accordingly, a new “zip code” attribute will be added to a plurality of payloads. Once the flow key management service 404 detects this new zip code attribute, the flow key management service 404 may add a plurality of flow keys corresponding to the new zip code attribute. A number of flow keys added may be based on a number of values of the zip code attribute detected in various payloads. For example, there are about 41,642 zip codes in the United States. There may be users of the cloud service from about 35,000 zip codes, merely as an example (for example, the cloud customer may not offer it’s service to all zip codes or all states of the country). Accordingly, for each of these 35,000 zip codes, the flow key management service 404 may define one or more corresponding flow keys.

Thus, in response to detection of a new attribute value and/or a new attribute altogether, the flow key management service 404 defines or adds one or more new corresponding flow keys. As and when the new flow keys are added or defined, the payload division service 408 adds new strata of payloads, and the analysis service 412 analyzes each such new stratum. In an example, a machine learning (ML) model may be trained to analyze and sample at least some or all of the payloads passing through the assurance proxy 174, and define new flow keys and/or update existing flow keys adaptively based on the payloads (e.g., the flow key management service 404 may comprise a ML model). In yet another example, a rule-based algorithm may be used to define new flow keys and/or update existing flow keys adaptively, based on the payloads.

In an example, for each of the time windows t0, t1, and so on, the analysis service 412 collects key metrics associated with each stratum of a plurality of strata, where each stratum includes a corresponding plurality of payloads. In an example, to maintain uniformity in the collected statistics, a uniform or common format of statistical data and metrics collection may be implemented by the analysis service 412. Example statistical metrics and data (such as information 508a, …, 508Q of FIG. 5) collected by the analysis service 412 and stored in the storage repository 186 includes counts, mean, median, standard deviation, error counts (e.g., schema validation errors and/or protocol errors), z-scores, etc. So, for example, the information 508a is essentially a log of the behavior of payloads within the stratum 502a for the time window t0, the information 508b is essentially a log of the behavior of payloads within the stratum 502b for the time window t0, and so on.

Note that the information 508a, …, 508K are stored in the storage repository 186. The actuals payloads used to generate such information are not stored in the storage repository 186, as the quantum of such payloads may be too high to be stored in the storage repository 186. The assurance proxy 174 performs a real-time or near real time analysis of the received payloads, and stores the corresponding statistical metrics and information 508a, …, 508K (for each time window) within the storage repository 186. In an example, the traffic analysis service 182 may include a buffer or a short-term memory, for temporarily storing the payloads, as and when the traffic analysis service 182 processes the payloads and generates the information 508a, …, 508K.

In an example, the time windows t0, t1, …, tR and so on may have a suitable duration, which may range from a fraction of a second or a few seconds to a few minutes or a few hours. In an example, the duration of each such time window may be determined and/or updated adaptively. Keeping the time window long may result in less storage requirement within the storage repository 186 for storing the information 508 - however, in such a case, some temporal variations in the payloads may be missed. This may result in missing detection of an anomalous issue. For example, an anomalous issue may occur for 10 seconds within payloads of a stratum 502. If the time window duration is, for example, 1 second, or 5 seconds, or 10 seconds, or 30 seconds, the information 508 may effectively capture information associated with the anomalous issue. However, if the time window duration is, for example, 1 minute or 2 minutes, the information 508 may not be able to effectively capture information associated with the anomalous issue (as the anomalous payloads may be averaged out by non-anomalous payloads during the relatively long time-window duration). Accordingly, in an example, the time window duration may be fine tuned by a human operator and/or by one or more pretrained ML models, e.g., based on a storage capacity of the storage repository 186, a desired resolution or accuracy in detecting anomalous issues, etc.

Thus, as described above, a number of flow keys and/or a duration of the time window may be based at least in part on a size of the storage repository 186. For example, increasing the number of flow keys results in a higher number of strata, resulting in a higher storage requirement within the storage repository 186 to store information 508 associated with the higher number of strata. On the other hand, decreasing the number of flow keys results in a lower number of strata, resulting in a lower storage requirement within the storage repository 186 to store information 508 associated with the lower number of strata. Similarly, decreasing the duration of the time window results in storage of more information corresponding to a higher number of time windows, thereby increasing the storage requirement within the storage repository 186, and vice versa. Accordingly, in an example, the number of flow keys and/or the duration of the time window may be fine-tuned based on, among other factors, the size of the storage repository 186.

As described above, the anomaly detection service 190 accesses the information 508 corresponding to each stratum and for each time window, aiming to detect anomalous issues with one or more strata for one or more time-windows. For example, the anomaly detection service 190 analyzes the statistical metrics of the information 508, such as comparing one or more such statistical metrics with preconfigured thresholds, detecting statistical z-scores, and/or uses other statistical tools to detect anomalous issues. Techniques used for detection of anomalous issues may be implementation specific, and may vary from one implementation to the next.

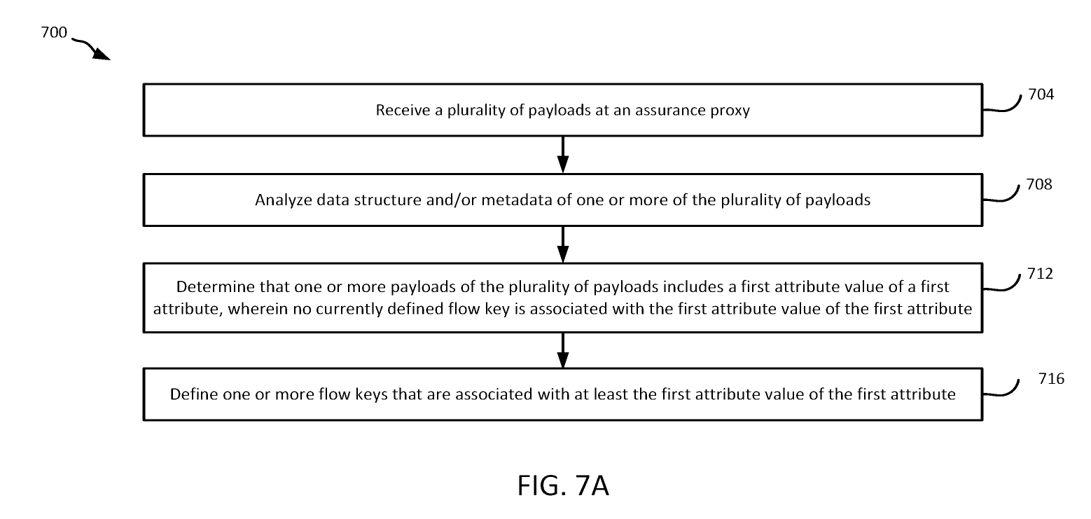

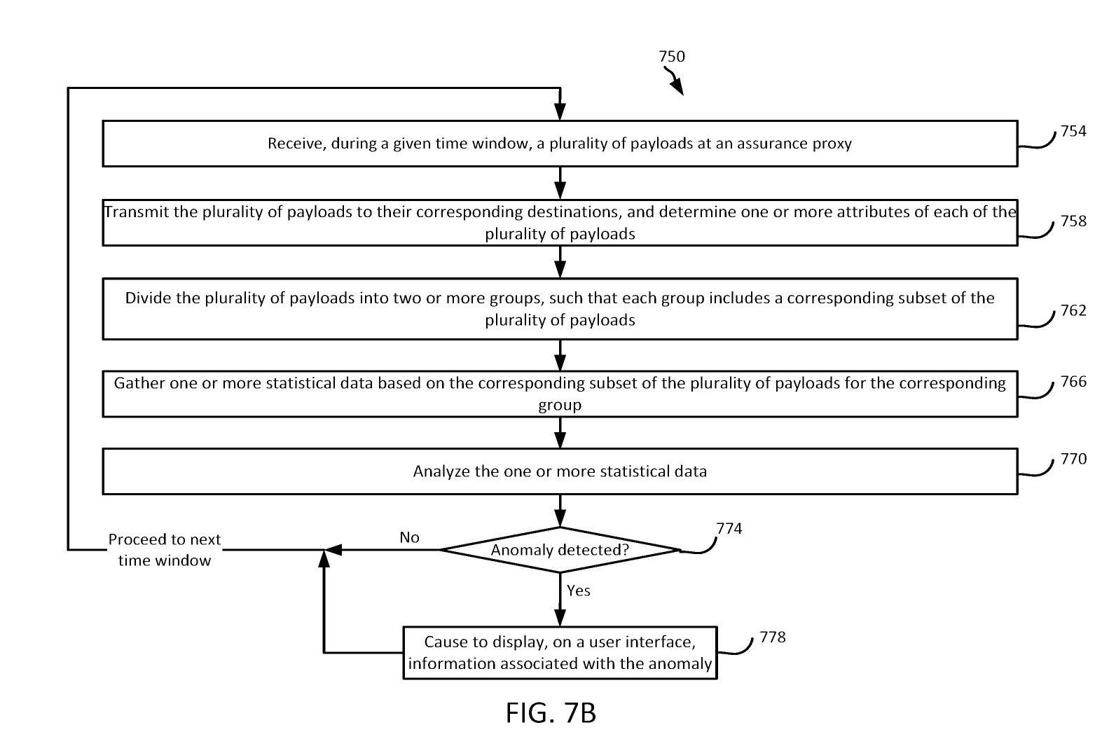

FIG. 7A illustrates a flowchart depicting a method 700 for defining new flow keys, based on monitoring payloads processed by the assurance proxy 174. At 704, a plurality of payloads is received at an assurance proxy. At 708, the data structure and/or metadata of one or more of the plurality of payloads are analyzed, e.g., by the flow key management service 404 and/or the payload division service 408.

At 712, a determination is made that one or more payloads of the plurality of payloads include a first attribute value of a first attribute, wherein no currently defined flow key is associated with the first attribute value of the first attribute. Thus, either a new attribute value, or a new attribute altogether is detected within the payloads. At 716, one or more flow keys, which are associated with at least the first attribute value of the first attribute, are defined, e.g., by the flow key management service 404, as also described above in further detail.

FIG. 7B illustrates a flowchart depicting a method 750 for federated statistical and traffic flow analysis, and anomaly detection for traffic flow passing through an assurance proxy 174 of an assurance administrator tenancy 170 of a cloud environment 100.

At 754 of the method 750, during a given time window (such as time window t0), a plurality of payloads is received at a gateway (e.g., the gateway 178) from first one or more components of a first section of the cloud environment. In an example, the plurality of payloads is destined for second one or more components of a second section of the cloud environment (e.g., see FIGS. 1-6).

At 758, one or more attributes of each of the plurality of payloads is determined, e.g., by the gateway 178 and/or the traffic analysis service 182 (such as by the payload division service 408).

Also at 758, each of the plurality of payloads is transmitted to its corresponding destination. Note that this transmission operation to corresponding destinations may be performed at 758, or at any point of the method 750, such as during or in between any of the operations 758, 762, 766, 770, 774, or 778. For example, operations 758 (e.g., determination of the one or more attributes), 762, 766, 770, 774, and/or 778 may be performed in real or near-real time (or may be performed offline as well in another example), whereas the transmission of the payloads to their intended destination may occur in real time or near-real time.

At 762, based at least in part on the one or more attributes of each of the payloads, the plurality of payloads is divided into two or more groups. For example, each group includes a corresponding subset of the plurality of payloads. The division of the payloads in two or more groups may be based on matching each payload with a corresponding flow key, and assigning a payload to a group corresponding to the matched flow key, as described above in detail.

At 766, for each group of the two or more groups, one or more statistical data is gathered (such as by the analysis service 412), e.g., based on the corresponding subset of the plurality of payloads for the corresponding group.

At 770, the statistical data for each group are analyzed, e.g., by the anomaly detection service 190. At 774, a determination is made as to whether an anomaly is detected for one or more groups, e.g., by the anomaly detection service 190.

If “No” at 774 (e.g., no anomaly is detected), the method 750 proceeds to the next time window and loops back to 754.

On the other hand, if “Yes” at 774 (e.g., an anomaly is detected for one or more groups), the method 750 proceeds to 778, in which information associated with the anomaly is caused to be displayed on a user interface (e.g., UI 520, see FIG. 5). Subsequently, the method 750 proceeds to the next time window and loops back to 754.

### COMPUTER SYSTEM ARCHITECTURE

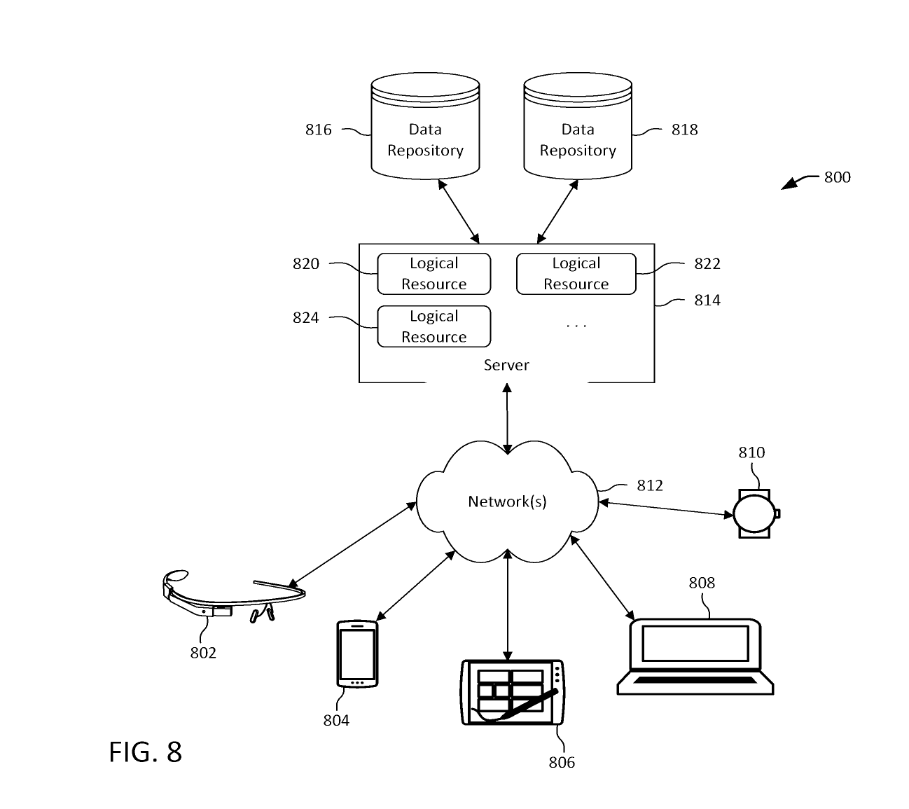

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for federated statistical and traffic flow analysis, and anomaly detection for traffic flow passing through an assurance proxy of an assurance administrator tenancy of a cloud environment. In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for federated statistical and traffic flow analysis, and anomaly detection for traffic flow passing through an assurance proxy of an assurance administrator tenancy of a cloud environment, in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows^{®}, Apple Macintosh^{®}, UNIX^{®} or UNIX-like operating systems, Linux^{®} or Linux-like operating systems such as Oracle^{®} Linux and Google Chrome^{®} OS) including various mobile operating systems (e.g., Microsoft Windows Mobile^{®}, iOS^{®}, Windows Phone^{®}, Android^{®}, HarmonyOS^{®}, Tizen^{®}, KaiOS^{®}, Sailfish^{®} OS, Ubuntu^{®} Touch, CalyxOS^{®}). Portable handheld devices may include cellular phones, smartphones, (e.g., an iPhone^{®}), tablets (e.g., iPad^{®}), and the like. Virtual personal assistants such as Amazon^{®} Alexa^{®}, Google^{®} Assistant, Microsoft^{®} Cortana^{®}, Apple^{®} Siri^{®}, and others may be implemented on devices with a microphone and/or camera to receive user or environmental inputs, as well as a speaker and/or display to respond to the inputs. Wearable devices may include Apple^{®} Watch, Samsung Galaxy^{®} Watch, Meta Quest^{®}, Ray-Ban^{®} Meta^{®}smart glasses, Snap^{®} Spectacles, and other devices. Gaming systems may include various handheld gaming devices, Internet-enabled gaming devices (e.g., a Microsoft Xbox^{®} gaming console with or without a Kinect^{®} gesture input device, Sony PlayStation^{®} system, Nintendo Switch^{®}, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk^{®}, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth^{®}, and/or any other wireless protocol), and/or any combination of these and/or other networks.

Server 814 may be composed of one or more general purpose computers, specialized server computers (including, by way of example, PC (personal computer) servers, UNIX^{®} servers, LINIX^{®} servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA^{®} servers, database servers, and the like. Exemplary database servers include without limitation those commercially available from Oracle^{®}, Microsoft^{®}, SAP^{®}, Amazon^{®}, Sybase^{®}, IBM^{®} (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads^{®} feeds, Twitter^{®} feeds, Facebook^{®} updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for federated statistical and traffic flow analysis, and anomaly detection for traffic flow passing through an assurance proxy of an assurance administrator tenancy of a cloud environment. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata^{®} storage device, or other data storage and retrieval tool such as databases provided by Oracle Corporation^{®} and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

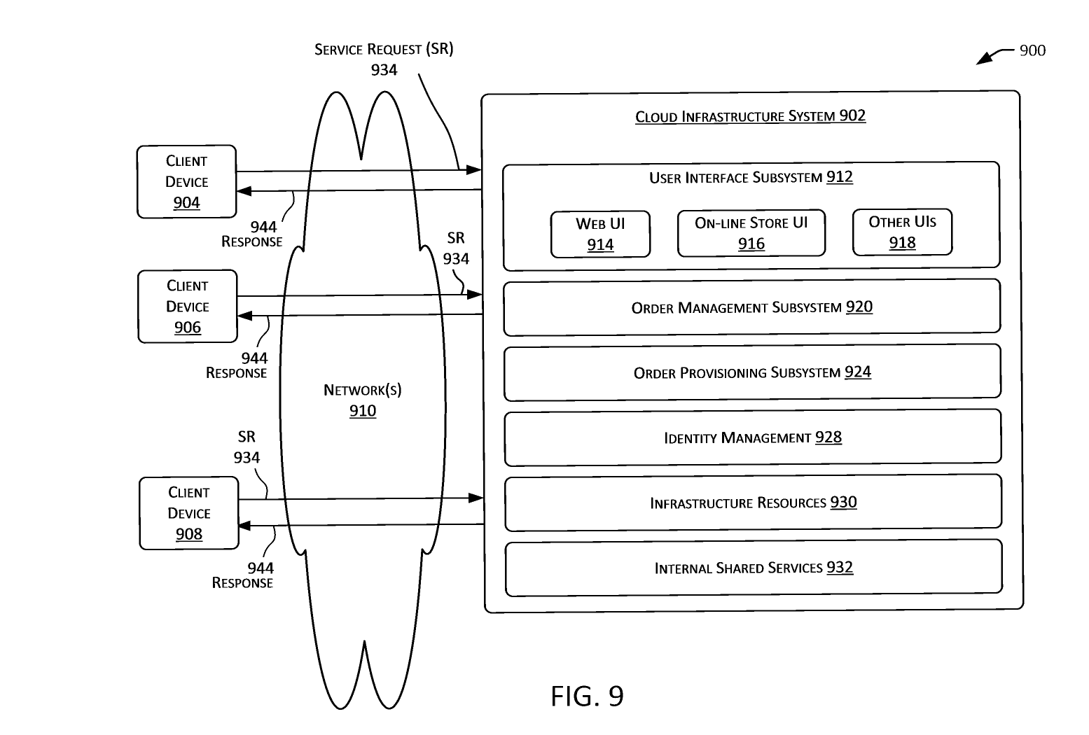

FIG. 9 is a simplified block diagram of a cloud-based system environment in which techniques are implemented for federated statistical and traffic flow analysis, and anomaly detection for traffic flow passing through an assurance proxy of an assurance administrator tenancy of a cloud environment, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer’s (“tenant’s”) own on-premise servers and systems. The cloud service provider’s systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation^{®}, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant’s client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, buIDL, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as "pods"). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant’s information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

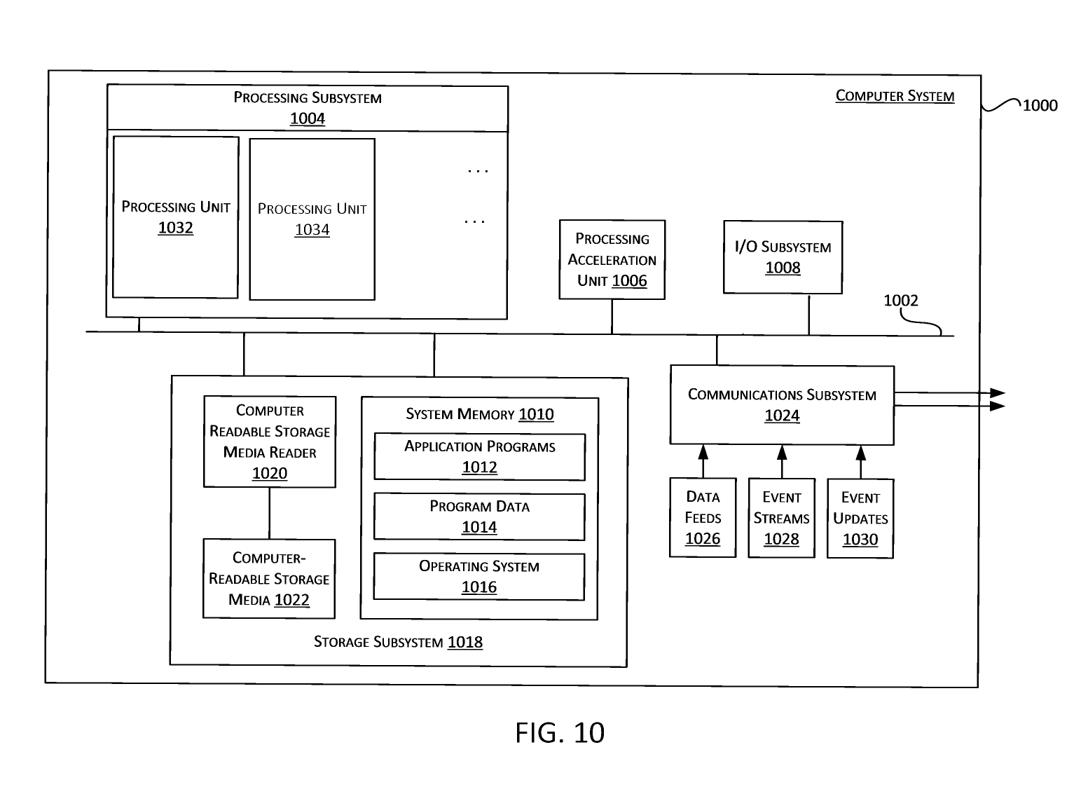

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest^{®} controller, Microsoft Kinect^{®} motion sensor, the Microsoft Xbox^{®} 360 game controller, or devices that provide an interface for receiving input using gestures and spoken commands. User interface input devices may also include eye gesture recognition devices such as a blink detector that detects eye activity (e.g., "blinking" while taking pictures and/or making a menu selection) from users and transforms the eye gestures as inputs to an input device. Additionally, user interface input devices may include voice recognition sensing devices that enable users to interact with voice recognition systems (e.g., Siri^{®} navigator or Amazon Alexa^{®}) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest^{®} or Microsoft HoloLens^{®} may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows^{®}, Apple Macintosh^{®}, and/or Linux^{®} operating systems, a variety of commercially-available UNIX^{®} or UNIX-like operating systems (including without limitation the variety of GNU/Linux operating systems, the Oracle Linux^{®}, Google Chrome^{®} OS, and the like) and/or mobile operating systems such as iOS, Windows^{®} Phone, Android^{®} OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray^{®} disk, or other optical media. Computer-readable storage media 1022 may include, but is not limited to, Zip^{®} drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter^{®} feeds, Facebook^{®} updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone^{®} cellular phone, an iPad^{®} computing tablet, a personal digital assistant (PDA)), a wearable device (e.g., a Meta Quest^{®} head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
receiving, at a gateway of a cloud environment and during a first time-window, a plurality of payloads from first one or more components of a first section of the cloud environment, wherein the plurality of payloads are destined for second one or more components of a second section of the cloud environment;
determining one or more attributes of each of the plurality of payloads;
based at least in part on the one or more attributes of each of the payloads, dividing the plurality of payloads into two or more groups, such that each group includes a corresponding subset of the plurality of payloads;
for each group of the two or more groups, gathering one or more statistical data based on the corresponding subset of the plurality of payloads for the corresponding group;
analyzing the one or more statistical data, to detect an anomalous issue with at least one group of the two or more groups; and
causing to display, on a user interface, information associated with the anomalous issue.

2. The non-transitory computer-readable medium of claim 1, wherein the operations include:
receiving, at the gateway of the cloud environment and during a second time-window that occurs subsequent to the first time-window, another plurality of payloads from the first one or more components of the first section of the cloud environment, wherein the other plurality of payloads are destined for the second one or more components of the second section of the cloud environment;
determining one or more attributes of each of the other plurality of payloads;
dividing the other plurality of payloads into another two or more groups, such that each group of the other two or more groups includes a corresponding subset of the other plurality of payloads;
for each group of the other two or more groups, gathering another one or more statistical data based on the corresponding subset of the other plurality of payloads for the corresponding group;
analyzing the other one or more statistical data, to detect another anomalous issue with at least another group of the other two or more groups; and
causing to display, on the user interface, information associated with the other anomalous issue.

3. The non-transitory computer-readable medium of claim 1, wherein dividing the plurality of payloads into two or more groups comprises:
accessing a plurality of flow keys, each flow key associated with corresponding one or more attribute values;
in response to one or more attributes of a first payload of the plurality of payloads matching at least corresponding one or more attribute values of a first flow key, grouping the first payload to a first group associated with the first flow key; and
in response to one or more attributes of a second payload of the plurality of payloads matching at least corresponding one or more attribute values of a second flow key, grouping the first payload to a second group associated with the second flow key.

4. The non-transitory computer-readable medium of claim 3, wherein:
the first flow key is associated with (i) a first attribute value of a first attribute and (ii) a second attribute value of a second attribute;
the second flow key is associated with (i) a third attribute value of the first attribute and (ii) a fourth attribute value of the second attribute;
the one or more attributes of the first payload matches with the first attribute value of the first attribute and the second attribute value of the second attribute; and
the one or more attributes of the second payload matches with the third attribute value of the first attribute and the fourth attribute value of the second attribute.

5. The non-transitory computer-readable medium of claim 3, wherein the plurality of payloads is a first plurality of payloads, and wherein the operations include:
analyzing a second plurality of payloads; and
defining a first flow key of the plurality of flow keys, based at least in part on analyzing the second plurality of payloads.

6. The non-transitory computer-readable medium of claim 5, wherein defining the first flow key of the plurality of flow keys comprises:
analyzing a data structure and/or metadata of one or more of the second plurality of payloads;
based at least in part on analyzing a data structure and/or metadata of one or more of the second plurality of payloads, determining that one or more payloads of the second plurality of payloads includes a first attribute value of a first attribute, wherein no currently defined flow key is associated with the first attribute value of the first attribute; and
defining the first flow key that is associated with at least the first attribute value of the first attribute.

7. The non-transitory computer-readable medium of claim 6, wherein the first flow key is associated with a combination of at least (i) the first attribute value of the first attribute and (ii) a second attribute value of a second attribute.

8. The non-transitory computer-readable medium of claim 3, wherein:
the one or more statistical data for each group and for each of a plurality of time windows are stored within a storage repository;
the operations include adaptively updating a number of flow keys within the plurality of flow keys, based at least in part on an available storage capacity and/or a total storage capacity of the storage repository; and
adaptively updating the number of flow keys comprises adding one or more flow keys to the plurality of flow keys, or deleting one or more flow keys from the plurality of flow keys.

9. The non-transitory computer-readable medium of claim 1, wherein the one or more statistical data comprises at least one of a mean, a count, a median, a standard deviation, an error count, and a z-score.

10. The non-transitory computer-readable medium of claim 1, wherein:
the first section of the cloud environment is within a first tenancy of the cloud environment;
the second section of the cloud environment is within a second tenancy of the cloud environment that is different from the first tenancy; and
the gateway is within a third tenancy of the cloud environment that is different from each of the first tenancy and the second tenancy.

11. The non-transitory computer-readable medium of claim 10, wherein the first tenancy and the second tenancy are rented out to a same cloud customer of the cloud environment.

12. The non-transitory computer-readable medium of claim 11, wherein the third tenancy is operated by an assurance administrator responsible for regulating one or more operations of the cloud customer within the cloud environment.

13. The non-transitory computer-readable medium of claim 1, wherein:
the first section of the cloud environment is within a first cloud region of a first tenancy of the cloud environment;
the second section of the cloud environment is within a second cloud region of the first tenancy of the cloud environment; and
the gateway is within a second tenancy of the cloud environment that is different from the first tenancy.

14. A method comprising:
receiving, at a gateway of a cloud environment and during a first time-window, a plurality of payloads from first one or more components of a first section of the cloud environment, wherein the plurality of payloads are destined for second one or more components of a second section of the cloud environment;
determining one or more attributes of each of the plurality of payloads;
based at least in part on the one or more attributes of each of the payloads, dividing the plurality of payloads into two or more groups, such that each group includes a corresponding subset of the plurality of payloads;
for each group of the two or more groups, gathering one or more statistical data based on the corresponding subset of the plurality of payloads for the corresponding group;
analyzing the one or more statistical data, to detect an anomalous issue with at least one group of the two or more groups; and
causing to display, on a user interface, information associated with the anomalous issue.

15. The method of claim 14, further comprising:
receiving, at the gateway of the cloud environment and during a second time-window that occurs subsequent to the first time-window, another plurality of payloads from the first one or more components of the first section of the cloud environment, wherein the other plurality of payloads are destined for the second one or more components of the second section of the cloud environment;
determining one or more attributes of each of the other plurality of payloads;
dividing the other plurality of payloads into another two or more groups, such that each group of the other two or more groups includes a corresponding subset of the other plurality of payloads;
for each group of the other two or more groups, gathering another one or more statistical data based on the corresponding subset of the other plurality of payloads for the corresponding group;
analyzing the other one or more statistical data, to detect another anomalous issue with at least another group of the other two or more groups; and
causing to display, on the user interface, information associated with the other anomalous issue.

16. The method of claim 14, wherein dividing the plurality of payloads into two or more groups comprises:
accessing a plurality of flow keys, each flow key associated with corresponding one or more attribute values;
in response to one or more attributes of a first payload of the plurality of payloads matching at least corresponding one or more attribute values of a first flow key, grouping the first payload to a first group associated with the first flow key; and
in response to one or more attributes of a second payload of the plurality of payloads matching at least corresponding one or more attribute values of a second flow key, grouping the first payload to a second group associated with the second flow key.

17. The method of claim 16, wherein:
the one or more statistical data for each group and for each of a plurality of time windows are stored within a storage repository;
the method further comprises adaptively updating a number of flow keys within the plurality of flow keys, based at least in part on an available storage capacity and/or a total storage capacity of the storage repository; and
adaptively updating the number of flow keys comprises adding one or more flow keys to the plurality of flow keys, or deleting one or more flow keys from the plurality of flow keys.

18. The method of claim 14, wherein:
the first section of the cloud environment is within a first tenancy of the cloud environment;
the gateway is within a second tenancy of the cloud environment that is different from the first tenancy; and
the second section of the cloud environment is within one of (i) the first tenancy, or (ii) a third tenancy of the cloud environment that is different from the first tenancy and the second tenancy.

19. A system comprising:
one or more processors;
a storage repository; and
one or more non-transitory computer-readable media storing instructions, which, when executed by the system, cause the system to perform operations including:
receiving, at a gateway of a cloud environment and during a first time-window, a plurality of payloads from first one or more components of a first section of the cloud environment, wherein the plurality of payloads are destined for second one or more components of a second section of the cloud environment;
determining one or more attributes of each of the plurality of payloads;
based at least in part on the one or more attributes of each of the payloads, dividing the plurality of payloads into two or more groups, such that each group includes a corresponding subset of the plurality of payloads;
for each group of the two or more groups, gathering one or more statistical data based on the corresponding subset of the plurality of payloads for the corresponding group;
analyzing the one or more statistical data, to detect an anomalous issue with at least one group of the two or more groups; and
causing to display, on a user interface, information associated with the anomalous issue.

20. The system of claim 19, wherein:
the first section of the cloud environment is within a first tenancy of the cloud environment;
the gateway is within a second tenancy of the cloud environment that is different from the first tenancy; and
the second section of the cloud environment is within one of (i) the first tenancy, or (ii) a third tenancy of the cloud environment that is different from the first tenancy and the second tenancy.
